(19) United States
(12) Patent Application Publication
(10) Pub. No.: US 2017/0252239 A1
(43) Pub. Date: Sep. 7, 2017

(54) Adjustable Chair Assembly

(71) Applicant: Synetik Ergocare Inc., Joliette (CA)

(72) Inventors: Frédéric Nadeau, Joliette (CA); Vincent Charest, Joliette (CA); Caroline Saulnier, Joliette (CA); Jacques Harnois, Joliette (CA); Garry Savage, Terrebonne (CA); Daniel Pellerin, Terrebonne (CA)

(21) Appl. No.: 15/446,648

(22) Filed: Mar. 1, 2017

Related U.S. Application Data
(60) Provisional application No. 62/301,881, filed on Mar. 1, 2016.

(51) Int. Cl. A61G 5/10; A61G 5/12

(52) U.S. Cl. CPC A61G 5/1062; A61G 5/125; A61G 5/121; A61G 5/122; A61G 5/128; A61G 5/1091; A61G 5/1059; A61G 5/1064; A61G 5/1067

(57) ABSTRACT

An adjustable chair assembly comprising a frame, a seat assembly, a back assembly and at least one of a seat space-filling element and a back space-filling element. The seat assembly extends along a seat plane and comprises a first seat element and a second seat element adjustably positionable with respect to one another along the seat plane and together defining a support surface of the seat assembly. The back assembly extends along a back plane and comprises a first back element and a second back element adjustably positionable with respect to one another along the back plane and together defining a support surface of the back assembly. A central gap is defined in at least one of the support surfaces and the at least one of the seat space-filling element and the back space-filling element is removably insertable in the central gap of the corresponding support surface.

### CROSS REFERENCE TO RELATED APPLICATION

This application claims the benefit under 35 U.S.C. §119(e) of U.S. provisional patent application No. 62/301,881 which was filed on Mar. 1, 2016. The entirety of the aforementioned application is herein incorporated by reference.

### TECHNICAL FIELD OF THE INVENTION

The present invention relates to the field of chairs for physically impaired individuals. More particularly, the present invention relates to an adjustable chair assembly for physically impaired individuals, the chair being adjustable along multiple adjustment axis to match the size of the user and allowing an easy and affordable solution to provide comfortable seating to the user upon a size adjustment of the chair.

### BACKGROUND

It is known in the art that physically impaired individuals can have special requirements in the use of chair assemblies. For example, such requirements can relate to the required additional support for the individual when seated in the chair assembly. Hence, it is common to design and produce specialized chair assemblies having the required characteristics to fulfill the support requirements of persons having handicaps.

Such specialized chair assemblies are generally costly to produce and therefore it is desirable that the chair can be used by a user for an extended time period. It is therefore desirable that the chair assembly can adapt to the user even as he changes in size. This is particularly relevant for children, which are subject to substantial growth, and for which the chair assembly should advantageously be adaptable to the child as it grows (or at least during a period of time). In other words, it is desirable to minimize the occurrences of having to buy a new chair assembly as a result of the child having outgrown its original chair.

Known to the applicant are some adjustable chairs, where the configuration of the chair can be modified as the child grows, to adapt to the growing child. Such adjustable chair assemblies however tend to suffer from several drawbacks. For example and without being limitative, some adjustable chairs tend to be bulky and/or heavy, even in a configuration where they are meant to adapt to a smaller child. Moreover, known adjustable chairs generally either do not provide an adequate adjustment mechanism for the seat and/or back assemblies, independent of each other and/or an easy handling and operation of said adjustment mechanism. Furthermore, known adjustable chairs do not provide easy adaptation of the support surface provided by the seat and/or back assemblies, following a size adjustment thereof, to provide a comfortable user engaging surface. For example, in many cases, new tailor made cushions are required to be made following a size adjustment of the chair.

In view of the above, there is a need for an improved adjustable chair assembly which, by virtue of its design and components, would be able to overcome or at least minimize some of the above-discussed prior art concerns.

### BRIEF SUMMARY OF THE INVENTION

In accordance with a first general aspect, there is provided an adjustable chair assembly comprising a frame, a seat assembly, a back assembly and at least one of a seat space-filling element and a back space-filling element. The seat assembly extends along a seat plane and is operatively connected to the frame. The seat assembly comprises a first seat element and a second seat element adjustably positionable with respect to one another along the seat plane and together defining a support surface of the seat assembly. The back assembly extends along a back plane and is operatively connected to the frame. The back assembly comprises a first back element and a second back element adjustably positionable with respect to one another along the back plane and together defining a support surface of the back assembly. The positioning of the first back element and the second back element of the back assembly is independent from positioning of the first seat element and the second seat element of the seat assembly. A central gap is defined in at least one of the support surface of the seat assembly and the support surface of the back assembly and the at least one of the seat space-filling element and the back space-filling element is removably insertable in the central gap of the corresponding one of the support surface of the seat assembly and the support surface of the back assembly to substantially fill the corresponding central gap.

In an embodiment, the support surface of the seat assembly and the support surface of the back assembly each have a central gap defined therein. The adjustable chair assembly comprising the seat space-filling element removably insertable in the central gap defined in the support surface of the seat assembly and the back space-filling element removably insertable in the central gap defined in the support surface of the back assembly.

In an embodiment, the central gap defined in the support surface of the seat assembly and the central gap defined in the support surface of the back assembly are expandable and the adjustable chair assembly comprises a plurality of seat space-filling elements of varying sizes removably insertable in the central gap defined in the support surface of the seat assembly and a plurality of back space-filling elements of varying sizes removably insertable in the central gap defined in the support surface of the back assembly.

In an embodiment, a size of each one of the plurality of seat space-filling elements and back space-filling elements is calculated to match a size of at least one of the seating assembly and the back assembly according to statistical sizing charts for desired users of the adjustable chair assembly.

In an embodiment, the first seat element and the second seat element of the seat assembly are each movable along a lateral axis and a longitudinal axis of the seat plane.

In an embodiment, the first back element and the second back element of the back assembly are each movable along a lateral axis and a vertical axis of the back plane.

In an embodiment, the frame includes a base support operatively connected to a seat plate and a back plate, the first seat element and the second seat element of the seat assembly are adjustably securable to the seat plate and the first back element and the second back element of the back assembly are adjustably securable to the back plate.

In an embodiment, the first seat element and the second seat element each include a base and a cushioned pad securable to the plate. The seat assembly further comprises a seat positioning system including a comb-shaped slot defined in the seat plate for each one of the first seat element and the second seat element with a threaded pin extending from the base of each one of the first seat element and the second seat element and engageable in the corresponding comb-shaped slot. Each threaded pin has a knob for tightening thereof.

In an embodiment, the comb-shaped slot defined in the seat plate for each one of the first seat element and the second seat element is oriented to define a plurality of laterally extending slots connected at one end to a longitudinally extending slot.

In an embodiment, the first back element and the second back element each include a base and a cushioned pad securable to the plate. The back assembly further comprises a back positioning system including a comb-shaped slot defined in the back plate for each one of the first back element and the second back element with a threaded pin extending from the base of each one of the first back element and the second back element and engageable in the corresponding comb-shaped slot. Each threaded pin has a knob for tightening thereof.

In an embodiment, the comb-shaped slot defined in the back plate for each one of the first back element and the second back element is oriented to define a plurality of laterally extending slots connected at one end to a vertically extending slot.

In an embodiment, the seat space-filling element and the back space-filling element includes a cushioned insert.

In accordance with another general aspect, there is also provided an adjustable chair assembly comprising a frame, a seat assembly, a back assembly. The frame has a base support operatively connected to a seat plate and a back plate. The seat assembly extends along a seat plane and comprises a first seat element and a second seat element adjustably securable to the seat plate and extending along the seat plane. The first seat element and the second seat element together define a support surface of the seat assembly with a central gap defined therein. The back assembly extends along a back plane and comprises a first back element and a second back element adjustably securable to the back plate and extending along the back plane. The first back element and the second back element together define a support surface of the back assembly with a central gap defined therein. The adjustable chair assembly further comprises a seat space-filling element removably insertable in the central gap defined in the support surface of the seat assembly and substantially filling the central gap thereof and a back space-filling element removably insertable in the central gap defined in the support surface of the back assembly and substantially filling the central gap thereof.

In an embodiment, the central gap defined in the support surface of the seat assembly is expandable and the adjustable chair assembly comprises a plurality of seat space-filling elements of varying sizes removably insertable in the central gap defined in the support surface of the seat assembly.

In an embodiment, the central gap defined in the support surface of the back assembly is expandable and the adjustable chair assembly comprises a plurality of back space-filling elements of varying sizes removably insertable in the central gap defined in the support surface of the back assembly.

In an embodiment, the first seat element and the second seat element of the seat assembly are each movable along a lateral axis and a longitudinal axis of the seat plane.

In an embodiment, the first seat element and the second seat element each include a base and a cushioned pad securable to the plate. The seat assembly further comprises a seat positioning system including a comb-shaped slot defined in the seat plate for each one of the first seat element and the second seat element with a threaded pin extending from the base of each one of the first seat element and the second seat element and engageable in the corresponding comb-shaped slot. Each threaded pin has a knob for tightening thereof.

In an embodiment, the comb-shaped slot defined in the seat plate for each one of the first seat element and the second seat element is oriented to define a plurality of laterally extending slots connected at one end to a longitudinally extending slot.

In an embodiment, the first back element and the second back element of the back assembly are each movable along a lateral axis and a vertical axis of the back plane.

In an embodiment, the first back element and the second back element each include a base and a cushioned pad securable to the plate. The back assembly further comprises a back positioning system including a comb-shaped slot defined in the back plate for each one of the first back element and the second back element with a threaded pin extending from the base of each one of the first back element and the second back element and engageable in the corresponding comb-shaped slot. Each threaded pin has a knob for tightening thereof.

In an embodiment, the comb-shaped slot defined in the back plate for each one of the first back element and the second back element is oriented to define a plurality of laterally extending slots connected at one end to a vertically extending slot.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a front perspective view of a chair assembly, in accordance with an embodiment.

FIG. 2 is a front perspective view of the chair assembly of FIG. 1, with a space-filling element of a seating assembly and a space-filling element of a back assembly removed.

FIG. 3 is a rear perspective view of the chair assembly for FIG. 1.

FIGS. 4A and 4B are bottom plan views of the chair assembly of FIG. 1, showing a positioning system of the seating assembly, the positioning system being shown in a smallest configuration in FIG. 4A and in a largest configuration in FIG. 4B.

FIGS. 5A and 5B are rear elevation views of the chair assembly for FIG. 1 with a protective cover removed, showing a positioning system of the back assembly, the positioning system being shown in a narrowest configuration in FIG. 5A and in a widest configuration in FIG. 5B.

FIGS. 6A to 6C are top views of the chair assembly of FIG. 1 according to different size configurations, the chair assembly being shown with small space-filling elements in FIG. 6A, medium space-filling elements in FIG. 6B and large space-filling elements in FIG. 6C.

FIGS. 7A to 7C are front elevation views of the chair assembly of FIG. 1 in the different size configurations, the chair assembly corresponding to the configuration of FIG. 6A in FIG. 7A, the configuration of FIG. 6B in FIG. 7B and the configuration of FIG. 6C in FIG. 7C.

FIG. 8 is a front perspective view of the chair assembly of FIG. 1, shown with a head rest, a set rest, arm rest, and lateral back support shown in extended configurations.

FIG. 9 is a front perspective view of the chair assembly of FIG. 1, shown with a cabaret mounted thereto and secured to a rolling base.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the adjustable chair assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the adjustable chair assembly, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

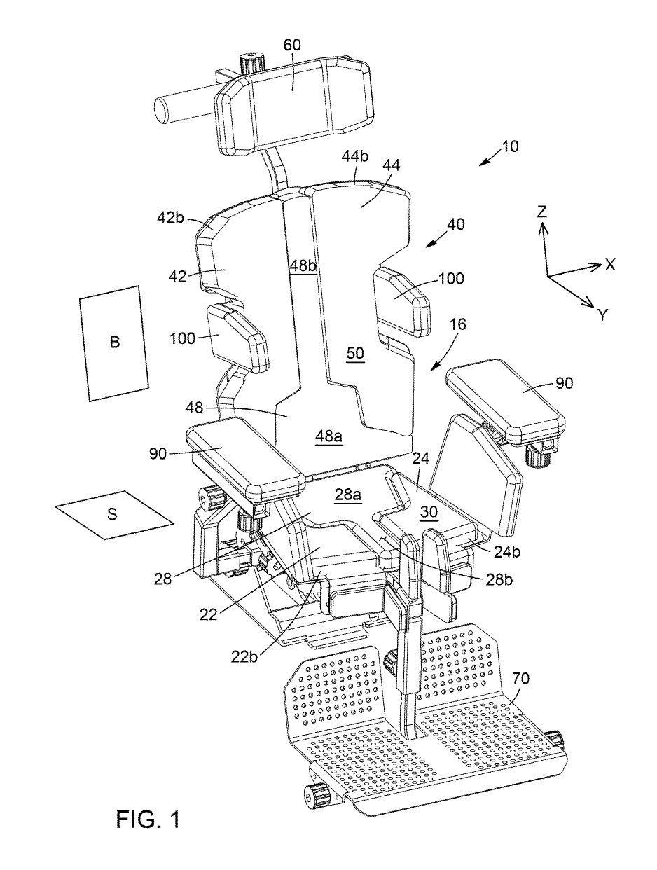

Referring generally to FIGS. 1 to 3, in accordance with one embodiment, there is provided a chair assembly 10. The chair assembly 10 has a frame 12 including a base support 14 operatively connected to a seat plate 26 and a back plate 46. The chair assembly 10 further includes a seat assembly 20 operatively connected to the seat plate 26 and a back assembly 40 operatively connected to the back plate 46. The seat assembly 20 and the back assembly 40 together define a seating area 16.

The seat assembly 20 is a structure extending along a seating plane S and includes a first seat element 22 and a second seat element 24 adjustably securable to the seat plate 26 and defining a support surface 30. As will be described in more details below, the first seat element 22 and the second seat element 24 are adjustably positionable with respect to one another, along the seat plane S. In other words, the first seat element 22 and the second seat element 24 are each movable with regard to the seat plate 26 to be moved towards or away from one another. In the embodiment shown, the first seat element 22 and the second seat element 24 are movable in a lateral direction (i.e. along a lateral axis X) and in a forward-backward direction (i.e. along a longitudinal axis Y) of the seat plane S. In view of the above, one skilled in the art will understand that the seat assembly 20 can be adjusted to expand and retract in width (along the lateral axis X) and in length (along the longitudinal axis Y) to adjust to the particular physical characteristics of a user and/or to expand with the growth of a growing user.

As will be described in more details below, the seat assembly 20 is configured to be adjustable in width (along the lateral axis X) and in length (along the longitudinal axis Y), through movement of the same components (the first seat element 22 and the second seat element 24) movable along both the lateral axis X and the longitudinal axis Y. In other words, expansion of the seat assembly 20 does not require movement of one component along the lateral axis X and a different component along the longitudinal axis Y.

In an embodiment, the first seat element 22 and the second seat element 24 each include a rigid base 22a, 24a and a cushioned pad 22b, 24b securable to the base 22a, 24a. In an embodiment, the cushioned pads 22b, 24b can be removable from the corresponding base 22a, 24a, for example for washing thereof.

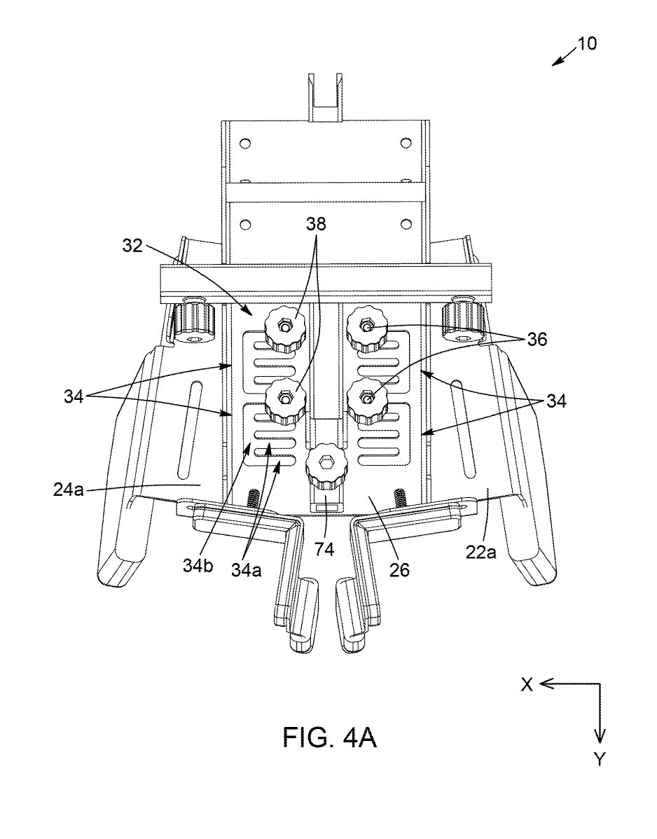

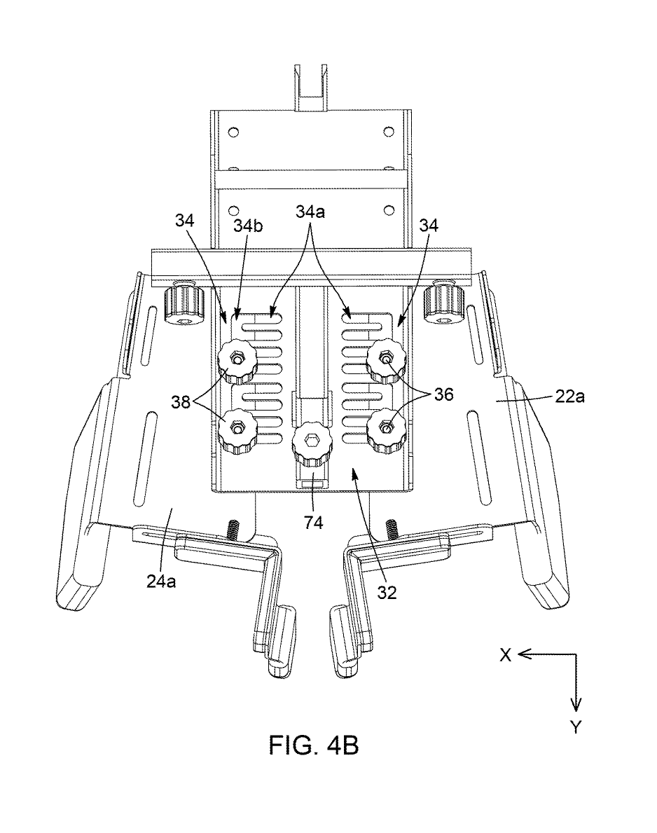

Referring to FIGS. 4A and 4B, in the embodiment shown, the seat assembly 20 further includes a seat positioning system 32 allowing easy adjustment of the seat assembly 20 (i.e. easy modification of the positioning of the first seat element 22 and the second seat element 24 with regard to the seat plate 26). For each one of the first seat element 22 and the second seat element 24, the seat positioning system 32 is configurable between a locked configuration where the corresponding one of the first seat element 22 and the second seat element 24 is locked in position with regard to the seat plate 26 and an unlocked configuration where it is displaceable with regard to the seat plate 26 along the lateral axis X and the longitudinal axis Y. In view of the above, it will be understood that the first seat element 22 and the second seat element 24 are independently connected to the seat plate 26 and can be independently moved and positioned thereabout to adjust the size and configuration of the seat assembly 20.

In the embodiment shown, the seat positioning system 32 includes at least one comb-shaped slot 34 (or array of toothed elements) defined in the seating plate 26, for each one of the first seat element 22 and the second seat element 24; at least one threaded pin 36 (or connecting element) extending from the first seat element 22 and the second seat element 24 and insertable in a corresponding comb-shaped slot 34; and a threaded knob 38 screwable onto each threaded pin 36. In the embodiment shown, two comb-shaped slots 34 are defined in the seating plate 26, for each one of the first seat element 22 and the second seat element 24, but one skilled in the art will understand that, in an alternative embodiment (not shown) only one or more than two comb-shaped slots 34 could be defined in the seating plate 26, for each one of the first seat element 22 and the second seat element 24. In the embodiment shown, the comb-shaped slots 34 are oriented to provide a plurality of laterally extending slots 34a connected at one end to a longitudinally extending slot 34b. Moreover, in the embodiment shown, the threaded knob 38 is screwable into the corresponding threaded pin 36 extending from the first seat element 22 or the second seat element 24, but one skilled in the art will understand that, in an alternative embodiment (not shown), the threaded pin 36 insertable in the comb-shaped slot 34 could extend from the knob 38 and be screwable into a threaded bore defined in the corresponding one of the first seat element 22 or the second seat element 24. In an alternative embodiment (not shown) micro adjustment slots (i.e. longitudinally extending micro slots) extending longitudinally from the laterally extending slots 34a of a short distance (i.e. a distance smaller than the distance between adjacent laterally extending slots 34a) could be provided to allow micro adjustment longitudinally, at successive positions along the laterally extending slots 34a.

In the embodiment shown, for each one of the first seat element 22 and the second seat element 24, the knob(s) 38 can be screwed (or tightened) onto the threaded pin(s) 36 to configure the seat positioning system 32 in the locked configuration where the corresponding one of the first seat element 22 and the second seat element 24 is pressed against the seat plate 16 and the components are engaged in a press fit configuration to prevent movement therebetween. The knob(s) 38 can also be selectively unscrewed (or untightened) from the threaded pin(s) 36, to configure the seat positioning system 32 in the unlocked configuration where the corresponding one of the first seat element 22 and the second seat element 24 can be moved with regard to the seat plate 26.

To move the corresponding one of the first seat element 22 and the second seat element 24 with regard to the seat plate 26, the threaded pin 36 thereof is moved along the comb-shaped slot 34 until the desired position is reached. It will be understood that the comb-shaped configuration of the slot 34 (i.e. a configuration with multiple laterally extending slots 34a connected at one end to a longitudinally slot 34b or vice-versa) allows the corresponding one of the first seat element 22 and the second seat element 24 to be simultaneously moved along the lateral axis X and the longitudinal axis Y.

Displacement along the lateral axis X can be performed through movement of the threaded pin 36 along one of the laterally extending slots 34a, while displacement along the longitudinal axis Y can be performed through movement of the threaded pin 36 between the laterally extending slots 34a (i.e. by moving the threaded pin to another one of the laterally extending slots 34a through the longitudinally extending slot 34b) or through movement of the threaded pin 36 along the longitudinally extending slot 34b. For example, in FIG. 4A, the seat assembly is shown in a smallest configuration, with the threaded pins 36 of the first seat element 22 and the second seat element 24 are being located at an inner end of the rearward located laterally extending slots 34a of the corresponding comb-shaped slot 34. Conversely, in FIG. 4B, the seat assembly 20 is shown in a largest configuration, with the threaded pins 36 of the first seat element 22 and the second seat element 24 being located at a forward end of the longitudinally extending slot 34b located at the outer end of the laterally extending slots 34a.

Referring back to FIGS. 1 to 3, the back assembly 40 is a structure substantially similar to the seat assembly 20, but rather configured to support the back of the user. The back assembly 40 extends along a back plane B and includes a first back element 42 and a second back element 44 adjustably securable to the back plate 46 and defining a support surface 50. As will once again be described in more details below, the first back element 42 and the second back element 44 are each movable with regard to the back plate 46 and are therefore adjustably positionable with respect to one another, along the back plane B. In the embodiment shown, the first back element 42 and the second back element 44 are movable in the lateral direction (i.e. along the lateral axis X) and in a vertical direction (i.e. along a vertical axis Z) of the back plane B. In view of the above, one skilled in the art will understand that the back assembly 40 can be adjusted to expand and retract in width (along the lateral axis X) and in height (along the vertical axis Z) to adjust to the particular physical characteristics of a user, such as a child, and/or to expand with the growth of a growing user.

As will be described in more details below, the back assembly 40 is also configured to be adjustable in width (along the lateral axis X) and in height (along the vertical axis Z), through movement of the same components (the first back element 42 and the second back element 44) movable along both the lateral axis X and the vertical axis Z. In other words, expansion of the back assembly 40 does not require movement of one component along the lateral axis X and a different component along the vertical axis Z.

In an embodiment, the first back element 42 and the second back element 44 each include a rigid base 42a, 44a and a cushioned pad 42b, 44b securable to the base 42a, 44a. In an embodiment, the cushioned pads 42b, 44b can be removable from the corresponding base 42a, 44a, for example for washing thereof.

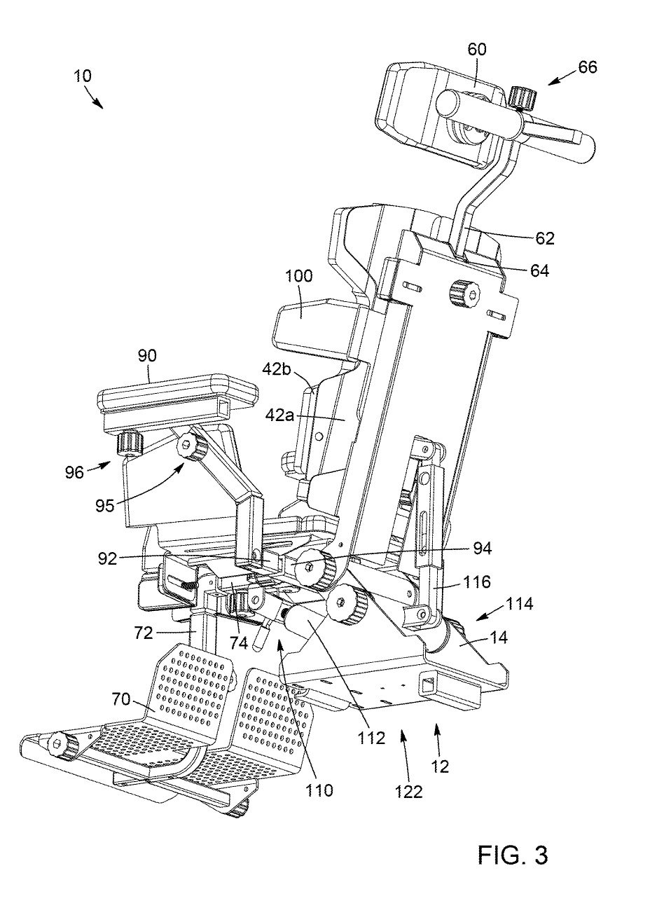

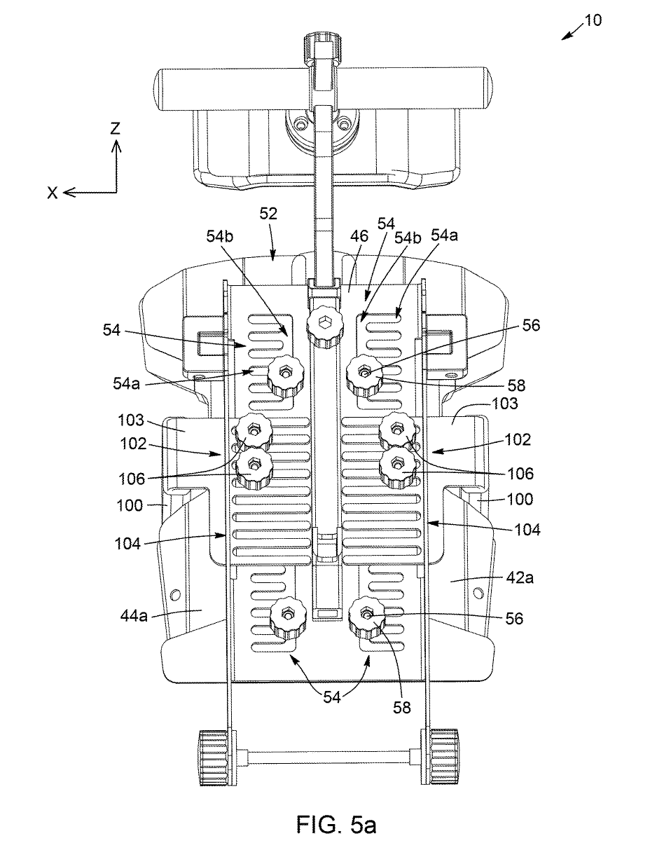

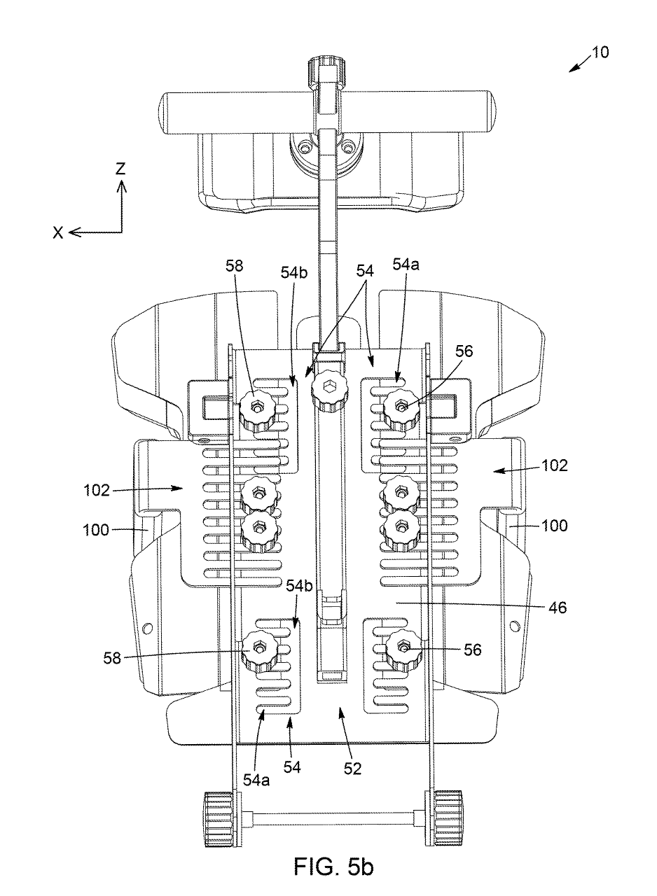

Referring specifically to FIGS. 5A and 5B, in the embodiment shown, the back assembly 40 also includes a back positioning system 52 allowing easy adjustment of the back assembly 40 (i.e. easy modification of the positioning of the first back element 42 and the second back element 44 with regard to the back plate 46). Similarly to the seat positioning system 32, the back positioning system 52 is configurable between a locked configuration where the corresponding one of the first back element 42 and the second back element 44 is locked in position with regard to the back plate 46 and an unlocked configuration where it is displaceable with regard to the back plate 46 along the lateral axis X and the vertical axis Z. The first back element 42 and the second back element 44 are also independently connected to the back plate 46 and can be independently moved and positioned thereabout to adjust the size and configuration of the back assembly 40. In FIGS. 5A and 5B, a protective cover (see FIG. 3) protecting the back positioning system 52 is removed to better see the back positioning system 52.

In the embodiment shown, the back positioning system 52 is similar to the above-described seat positioning system 32 and includes at least one comb-shaped slot 54 (or array of toothed elements) defined in the back plate 46, for each one of the first back element 42 and the second back element 44; at least one threaded pin 56 (or connecting element) extending from the first back element 42 and the second back element 44 and insertable in a corresponding comb-shaped slot 54; and a threaded knob 58 screwable onto each threaded pin 56. In the embodiment shown, the comb-shaped slots 54 are oriented to provide a plurality of laterally extending slots 54a connected at one end to a vertically extending slot 54b. In an alternative embodiment (not shown) micro adjustment slots (i.e. vertically extending micro slots) extending vertically from the laterally extending slots 54a of a short distance (i.e. a distance smaller than the distance between adjacent laterally extending slots 54a) could be provided to allow micro adjustment vertically at successive positions along the laterally extending slots 54a.

Given the similarity between the back positioning system 52 and the above described seat positioning system 32, one skilled in the art will understand that the teachings regarding the functioning of the seat positioning system 32 apply to the back positioning system 52 and need not be repeated herein, taking into account that the back positioning system 52 extends along the vertical axis Z rather than the longitudinal axis Y.

Hence, when configured in the unlocked configuration, the threaded pin 56 of the corresponding one of the first back element 42 and the second back element 44 can be moved along the comb-shaped slot 54 until the desired position is reached. For example, in FIG. 5A, the first back element 42 and the second back element 44 are shown in a narrowest configuration (and an intermediate height configuration), with the threaded pins 56 being located at an inner end of the laterally extending slots 54a of the corresponding comb-shaped slot 54. In FIG. 5B, the first back element 42 and the second back element 44 are shown in a widest configuration (and an intermediate height configuration greater than the one shown in FIG. 5A), with the threaded pins 56 being located at an outer end of longitudinally extending slots 54b being positioned at a greater height than the associated longitudinally extending slots 54b of FIG. 5A.

In view of the above, it will be understood that, in the embodiment shown, the adjustment of the seat assembly 20 is independent of an adjustment of the back assembly 40. In other words, in the embodiment shown, each one of the seat assembly 20 and the back assembly 40 can be adjusted, with the other one of the seat assembly 20 and the back assembly 40 remaining in a prior configuration or being adjusted to produce a greater or smaller expansion. In other words, the positioning systems 32, 52 with their easy adjustment mechanisms, allow the back assembly 40 and the seat assembly 20 to be expanded independently, to adapt to the growing morphology of a user, such as a child. With these adjustments, the child can take a proper and comfortable sitting position even as he grows, while using the same chair assembly 10. In addition, the positioning systems 32, 52 can help apply some corrections to the position of the user and improve the experience of the disabled person to accelerate their psychosocial development and promote motor skills.

Again referring to FIGS. 1 to 3, in the embodiment shown, each one of the seat assembly 20 and the back assembly 40 also respectively include a seat space-filling element 28 and a back space-filling element 48 each being shaped and sized to be inserted in a central gap 31, 51 (or depression) defined in the support surface 30, 50 of the corresponding one of the seat assembly 20 and the back assembly 40 (i.e. between sections of the first seat element 22 and the second seat element 24 along the seat plane S or the first back element 42 and the second back element 44 along the back plane B) to substantially fill the gap 31, 51 and provide a substantially flat support surface 30, 50. The support surfaces 30, 50 are the user engaging surfaces defined by the first seat element 22 and the second seat element 24 and the first back element 42 and the second back element 44 and which delimit the seating area 16 along the corresponding one of the seat plane S and the back plane B. In the embodiment shown, the central gap 31, 51 is defined between the cushioned pads 22b, 24b, 42b, 44b of the first seat element 22 and the second seat element 24 along the seat plane S and the first back element 42 and the second back element 44 along the back plane B. In the embodiment shown, a section of the plate 22a, 24a, 42a, 44a is not covered by the cushioned pads 22b, 24b, 42b, 44b and extends along a section of the bottom of the gap 31, 51.

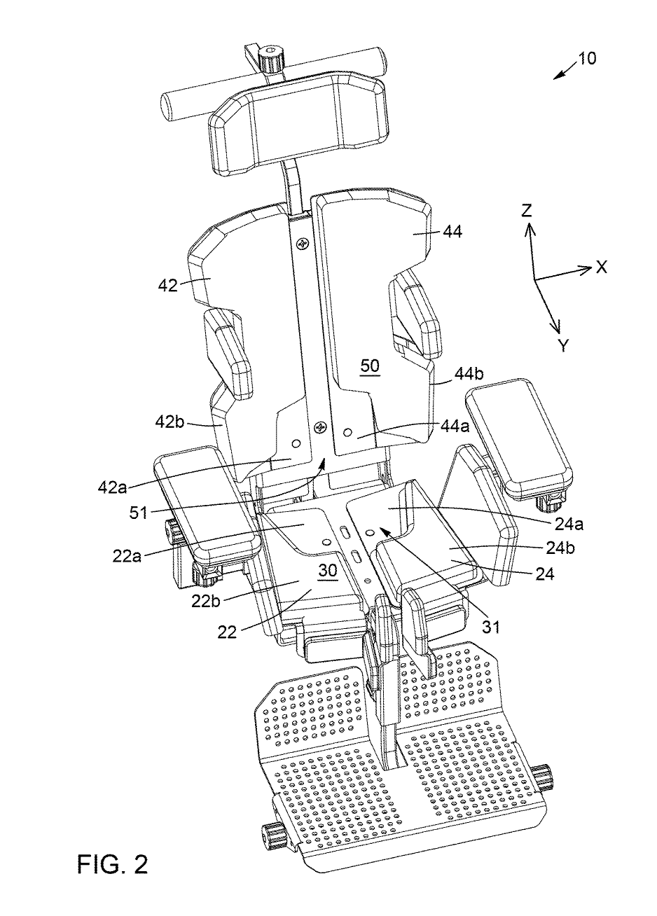

FIG. 1 shows the chair assembly 10 with space-filling elements 28, 48 mounted thereon, while FIG. 2 shows the chair assembly 10 with the space-filling elements 28, 48 removed.

In the embodiment shown and as can be seen more particularly in FIG. 2, each one of the seat assembly 20 and the back assembly 40 are configured to define a central gap 31, 51 in the corresponding support surface 30, 50 in all the configurations (or position) of the first seat element 22 and the second seat element 24 or the first back element 42 and the second back element 44 (i.e. the gap is defined in the corresponding support surface 30, 50 even when the seat assembly 20 and the back assembly 40 are configured in their smallest configurations). In other words, a space-filling element 28, 48 is used to substantially fill the central gap 31, 51 formed between the first seat element 22 and the second seat element 24 in the seat plane S or the first back element 42 and the second back element 44 in the back plane B, or sections thereof, whatever their position is. Larger space-filling elements 28, 48 are used upon separation of the first seat element 22 and the second seat element 24 in the seat plane S or the first back element 42 and the second back element 44 in the back plane B (i.e. upon expansion of the gaps 31, 51), as will be described in more details below.

In an alternative embodiment (not shown), at least one of the seat assembly 20 or the back assembly 40 could however be configured to define no gap in the corresponding support surface 30, 50 when configured in the smallest configuration, the gap being formed only by the expansion of the at least one of the seat assembly 20 or the back assembly 40. In other words, in such an alternative embodiment, in the smallest configuration, the at least one of the seat assembly 20 or the back assembly 40 could require no space-filling element 28, 48, the space-filling element 28, 48 being used only to fill the gap 31, 51 formed by the separation of the first seat element 22 and the second seat element 24 in the seat plane S or the first back element 42 and the second back element 44 in the back plane B.

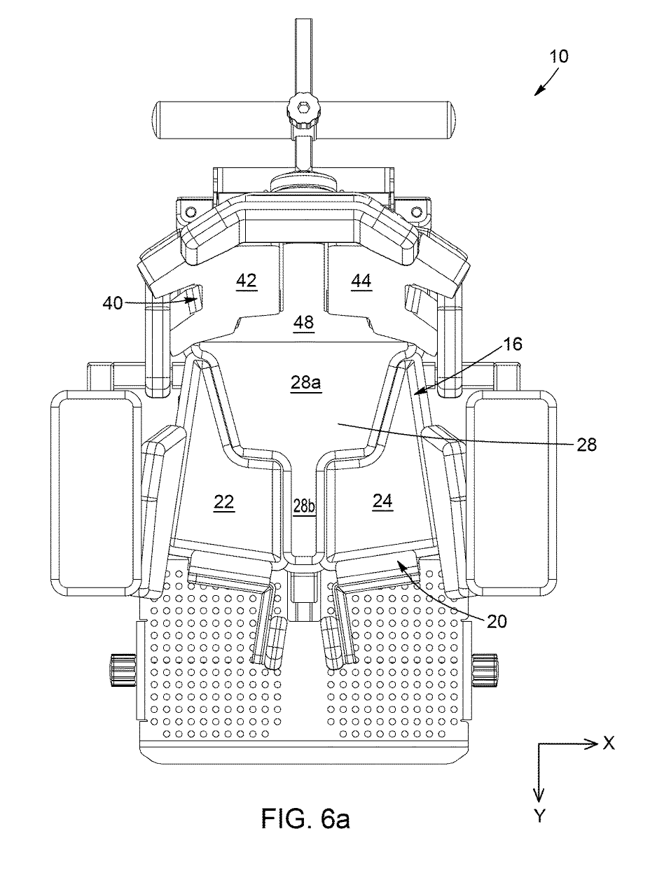

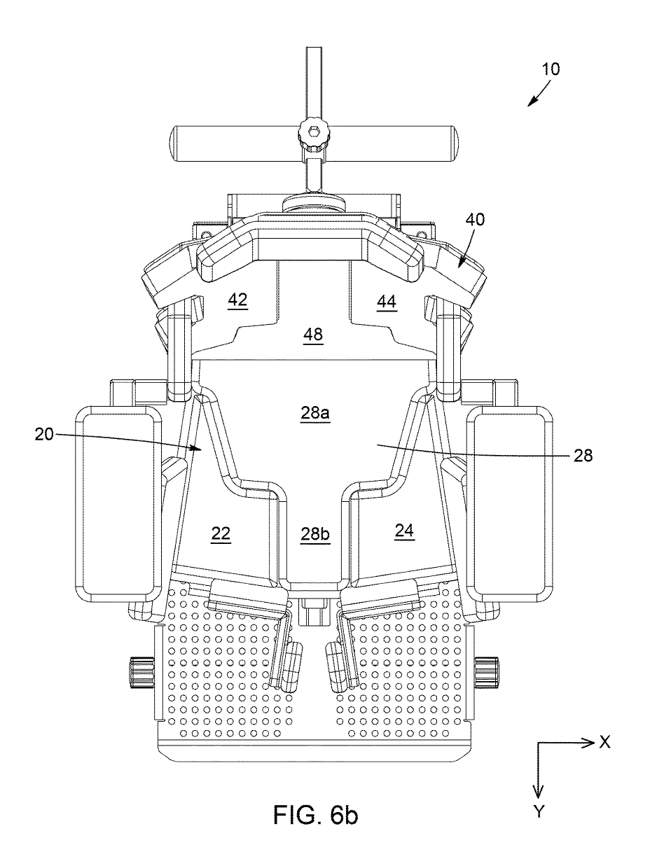

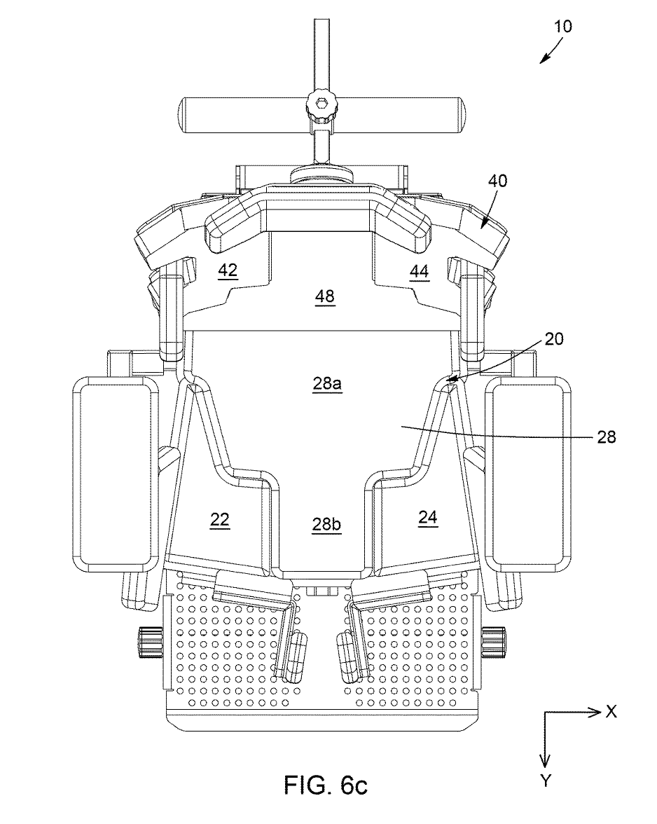

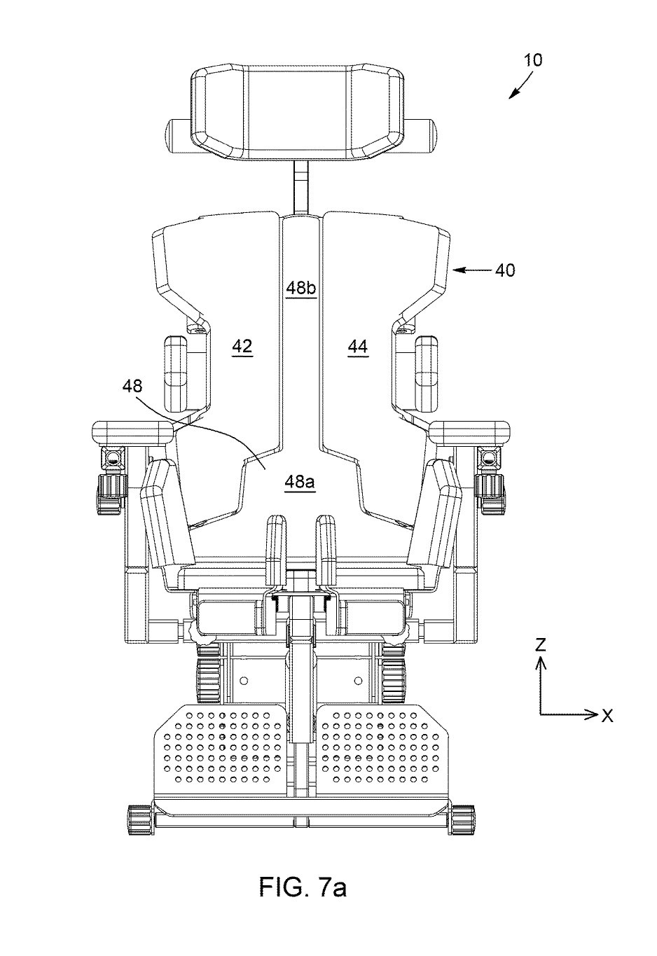

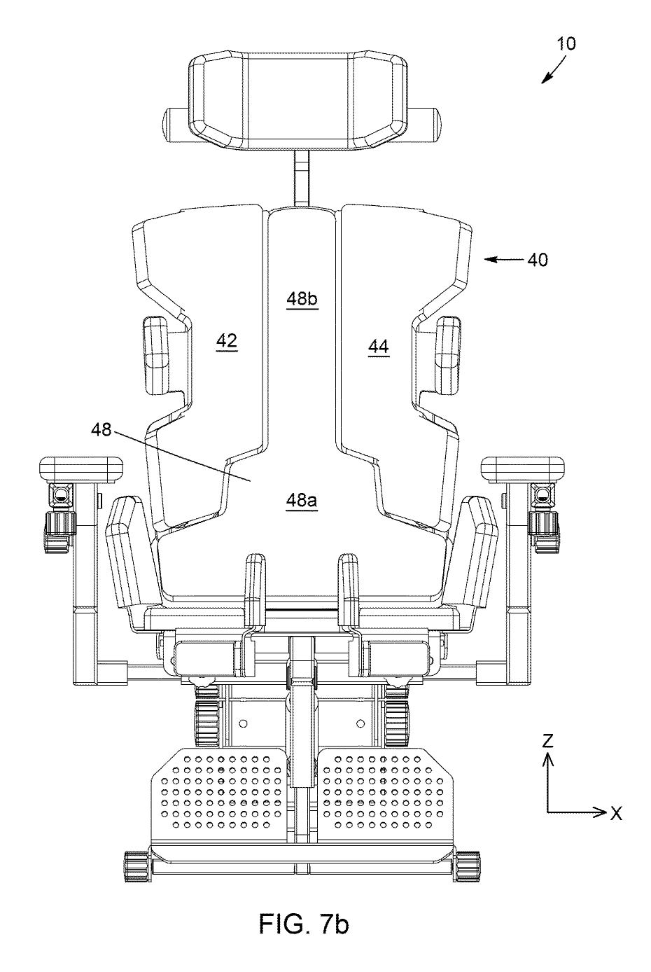

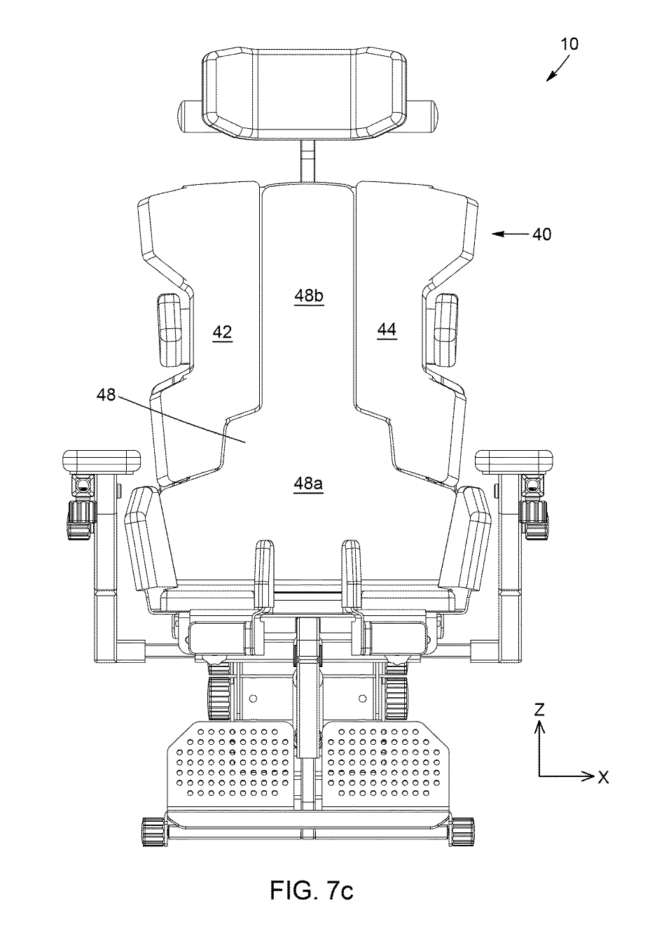

Referring to FIGS. 6A to 7C, in an embodiment, a plurality of space-filling elements 28, 48 of varying sizes are be provided, each one of the plurality of space-filling elements 28, 48 being shaped and sized to fit in a size matching central gap 31, 51 defined in the support surface 30, 50 of the corresponding one of the seat assembly 20 and the back assembly 40 and substantially fill the gap 31, 51. For example and without being limitative, FIGS. 6A to 6C show top perspective views of the chair assembly 10 in three dimensional configurations representing the typical adjustments corresponding to children of 2, 4 and 6 years of age. FIGS. 7A to 7C show front elevation views of the chair assembly 10 in the three-dimensional configurations representing the typical adjustments corresponding to children of 2, 4 and 6 years of age.

As can be seen in FIGS. 6A to 7C, as the seat assembly 20 and the back assembly 40 are expanded, larger space-filling elements 28, 48 can be used in the chair assembly 10 to fill the gaps 31, 51 between the sections of the first seat element 22 and the second seat element 24 in the seat plane S and the sections of the first back element 42 and the second back element 44 in the back plane B. For example and without being limitative, small size space-filling elements 28, 48 are used in the configuration shown in FIGS. 6A and 7A. Medium size space-filling elements 28, 48 are used in the configuration shown in FIGS. 6B and 7B where the first seat element 22 and the second seat element 24 are moved along the lateral axis X and the longitudinal axis Y to expand the seat assembly 20 and the first back element 42 and the second back element 44 are moved along the lateral axis X and the vertical axis Z to expand the back assembly 40. Large size space-filling elements 28, 48 are used in the configuration shown in FIGS. 6C and 7C where the first seat element 22 and the second seat element 24 are further moved along the lateral axis X and the longitudinal axis Y to further expand the seat assembly 20 and the first back element 42 and the second back element 44 are further moved along the lateral axis X and the vertical axis Z to further expand the back assembly 40.

In an embodiment, the sizing of the different space-filling elements 28, 48 provided with the chair assembly 10 can be calculated in conformity with statistical sizing charts or other relevant ergonomic data for the desired users of the chair. For example and without being limitative, in an embodiment, the sizing of the different space-filling elements 28, 48 provided with the chair assembly 10 can be calculated using child growth percentiles charts for the desired age interval of the children for which the chair assembly 10 is designed. In the embodiment shown, the chair assembly 10 includes small space-filling elements 28, 48, medium space-filling elements 28, 48 and large space-filling elements 28, 48 respectively being sized for the seating assembly 20 and the back assembly 40 to be sized according to child growth percentile charts of children of 2, 4 and 6 years of age. One skilled in the art will understand that, in alternative embodiment, sizing charts of other age groups or other relevant ergonomic data can also be used.

As mentioned above, the adjustment of the seat assembly 20 is independent of the adjustment of the back assembly 40. Therefore, in an alternative embodiment, one of the seat assembly 20 and the back assembly 40 can be expanded further than the other. Hence, in an embodiment (not shown), expansion of one of the seat assembly 20 and the back assembly 40 could require a larger size seat space-filling element 28 to be used in the seat assembly 20 than the back space-filling element 48 in the back assembly 40 or vice-versa.

One skilled in the art will also understand that, for each size of space-filling elements 28, 48 multiple adjustments of the seat assembly 20 along the lateral axis X and the longitudinal axis Y, and multiple adjustments of the back assembly 40 along the lateral axis X and the vertical axis Z are possible, the adjustment varying the distance between the space-filling elements 28, 48 and the corresponding ones of the first seat element 22 and the second seat element 24 and the first back element 42 and the second back element 44. In other words, depending on the positioning of the first seat element 22 and the second seat element 24 or the first back element 42 and the second back element 44, the corresponding size space-filling element 28, 48 can fit rather loosely or tightly in the central gap 31, 51 defined in the support surface 30, 50.

In an embodiment, the seat space-filling element 28 of the seat assembly 20 is removably securable to a section of the seat plate 26 and a section of the base 22a, 24a of the first seat element 22 and the second seat element 24 and the back space-filling element 48 of the back assembly 40 is removably securable to the back plate 46 and a section of the base 42a, 44a of the first back element 42 and the second back element 44. One skilled in the art will understand that several mounting means or methods can be used for temporarily securing the space-filling elements 28, 48 to the chair assembly 10. For example and without being limitative, in an embodiment, the space-filling elements 28, 48 can be attached to the chair assembly 10 using hook and loop fasteners such as Velcro™. One skilled in the art will understand that, in an alternative embodiment, other mounting means such as nuts and bolts or the like could be used for temporarily securing the space-filling elements 28, 48 to the chair assembly 10.

In the embodiment shown, the space-filling elements 28, 48 are cushioned inserts sized and shaped to substantially fill the gap in the corresponding support surface 30, 50 defined between the cushioned pads 22b, 24b of the first seat element 22 and second seat element 24 and the cushioned pads 42b, 44b of the first back element 42 and the second back element 44. In the embodiment shown, each one of the space-filling elements 28, 48 includes a first section 28a, 48a (or base section) having a width spanning over a substantial portion of the width of the corresponding one of the seating assembly 20 and the back assembly 40. Each one of the space-filling elements 28, 48 also includes a second section 28b, 48b (or elongated section) extending from the first section 28a, 48a and being smaller in width than the first section 28a, 48a. The second section 28b, 48b has an elongated profile with substantially straight lateral ends. In the embodiment shown, the first section 28a of the seat space-filling element 28 of the seat assembly 20 is positioned at a rear end of the seat assembly 20 to receive thereon most of the weight (or pressure) of a user seated in the seating area 16 of the chair assembly 10. Similarly, in the embodiment shown, the first section 48a of the back space-filling element 48 of the back assembly 40 is positioned at a lower end of the back assembly 40 to receive thereon most of the weight (or pressure) from the back of a user seated in the seating area 16 of the chair assembly 10. The wider design of the space-filling elements 28, 48 in the first sections 28a, 48a thereof and the positioning of the space-filling elements 28, 48 allows greater comfort to the user as it results in the majority of the weight of the user being received on the first sections 28a, 48a of the space-filling elements 28, 48, with the user substantially not feeling the joints between the space-filling elements 28, 48 and the first seat element 22, second seat element 24, first back element 42 and second back element 44.

It will be understood that, even though the above description refers to space-filling elements 28, 48 defined in the seat assembly 20 and the back assembly 40, in an alternative embodiment, only one of the seat assembly 20 and the back assembly 40 could be configured to receive a space-filling element 28, 48 in a central gap defined in the support surface 30, 50 thereof.

Referring to FIGS. 1 to 3 and 8, in an embodiment, the chair assembly 10 further includes several accessories to further enhance the usability and comfort thereof. For example and without being limitative, these additional accessories can include an adjustable headrest 60, an adjustable footrest 70, a cabaret support 80, adjustable armrests 90 and adjustable lateral torso supports 100. One skilled in the art will understand that, in alternative embodiments, other accessories can also be provided.

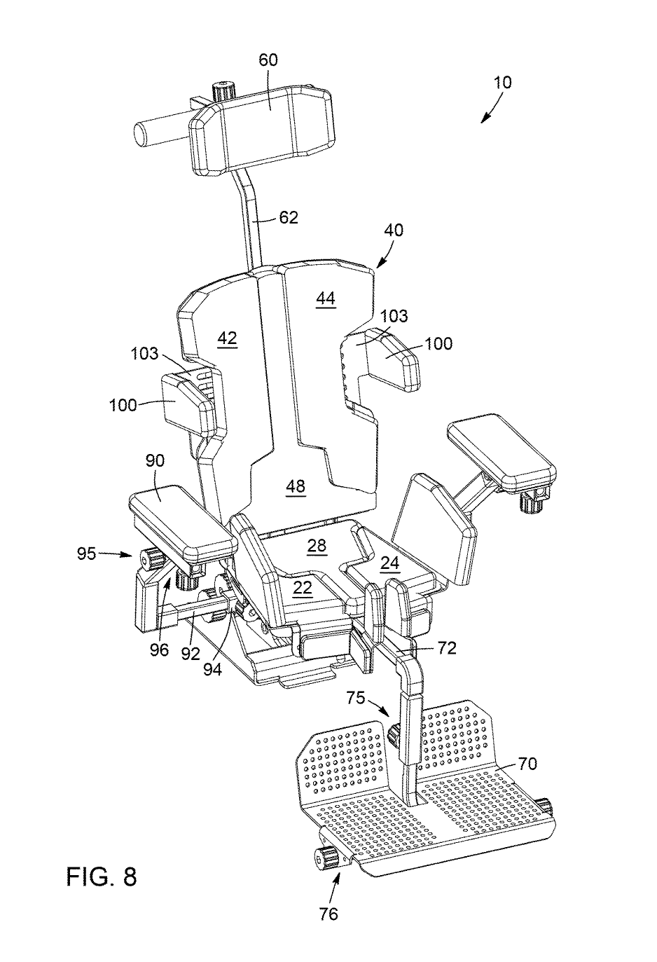

In the embodiment shown, the adjustable headrest 60 includes a headrest shaft 62 slidably engaged in a receiving tube 64 secured to the back plate 46 and extending along the vertical axis Z. The height of the headrest 60 can be adjusted by sliding the headrest shaft 62 in the receiving tube 64. FIGS. 1 and 8 respectively show the headrest 60 in a substantially retracted position (FIG. 1) and a further extended position (FIG. 8). The headrest 60 can also include a pivoting mechanism 66 allowing the headrest 60 to be adjusted to a desired angle, for comfort of the user.

In the embodiment shown, the adjustable footrest 70 includes a footrest shaft 72 slidably engaged in a receiving tube 74 secured to the seat plate 26 and extending along the longitudinal axis Y. The rearward/forward position of the footrest 70 can be modified by sliding the footrest shaft 72 in the receiving tube 74. In the embodiment shown, the footrest shaft 72 includes a height adjustment mechanism 75 where a section of the footrest shaft 72 is slidable into another section thereof to adjust the height of the footrest 70. FIGS. 1 and 8 respectively show the footrest 70 in a substantially retracted position (FIG. 1) and a position further forward and lower than in FIG. 1 (FIG. 8). The footrest 70 can also include a pivoting mechanism 76 allowing the footrest 70 to be adjusted to a desired angle, for comfort of the user.

In the embodiment shown, the armrests 90 each include an armrest shaft 92 slidably engaged in a receiving tube 74 secured to the seat plate 26 and extending along the lateral axis X. The lateral position of the armrests 90 can be modified by sliding the armrest shaft 92 in the receiving tube 94. In the embodiment shown, the armrests 90 also each include a height adjustment mechanism 95 where a section of the armrest shaft 92 is slidable into another section thereof to adjust the height of the armrest 90. The armrest 90 further includes a forward/backward adjustment mechanism section 96, allowing the armrest 90 to be moved in a forward/backward direction (i.e. along the longitudinal axis Y) with regard to the armrest shaft 92. FIGS. 1 and 8 respectively show the armrests 90 in a substantially retracted position (FIG. 1) and a laterally extended configuration (with the height and the forward/backward position remaining the same) (FIG. 8).

In an embodiment, the cabaret support 80 is made of transparent polycarbonate and includes anchors 82 along a lower surface therefor for securing the cabaret support 80 to the armrests 90. In an embodiment, the anchors 82 are displaceable along the lower surface of the cabaret support 80 to allow installation on the chair assembly 10, even in view of the above described size adjustments of the seat assembly 20, back assembly 40 and armrests 90. In other words, the armrests 90 are adjustable in width (along the lateral axis X), height (along the vertical axis Z) and forward/backward position (along the longitudinal axis Y), as mentioned above, with the anchors 82 being movable to match the position of the armrests 90. Transparency of the cabaret support 80 provides good visibility of the positioning of the user's legs. One skilled in the art will however understand that, in an alternative embodiment (not shown), the cabaret support 80 could also be offered in several colors and/or degrees of transparency.

In the embodiment shown, the adjustable lateral torso supports 100 are each adjustable in width (along the lateral axis X) and in height (along the vertical axis Z). In an embodiment, the adjustable lateral torso supports 100 each have a positioning system 102 with mounting plates 103 having comb-shaped slots 104 defined therein. Similarly to the seat positioning system 32 and back positioning system 52, the adjustable lateral torso supports 100 can be positioned by displacing corresponding pins along the comb-shaped slots 104 (and into adjacent slots thereof) until the desired position is reached. The adjustable lateral torso supports 100 are secured in place by tightening corresponding knobs 106. One skilled in the art will understand that, in an alternative embodiment, the adjustable lateral torso supports 100 could also be integral to the first back element 42 and the second back element 44 of the back assembly 40.

The adjustable headrest 60, adjustable footrest 70, cabaret support 80, adjustable armrests 90 and adjustable lateral torso supports 100 can be removable. One skilled in the art will understand that the positioning and adjustment systems defined above for the adjustable headrest 60, adjustable footrest 70, cabaret support 80, adjustable armrests 90 and adjustable lateral torso supports 100 are exemplary only and different positioning and adjustment systems allowing similar flexibility of adjustment could be used.

Referring to FIG. 3, the chair assembly 10 also includes an angulation adjustment system 110 for adjusting an angle of the back assembly 40 and/or an angle of the seat assembly 20 with respect to the base support 14. In an embodiment, the angulation adjustment system 110 allows possible adjustments of the back assembly 40 ranging between about 90 degrees and 120 degrees and possible adjustments of the seat assembly ranging between about 90 degrees and about 135 degrees. In the embodiment shown, the angulation adjustment system 110 includes a linear actuator 112 such as an hydraulic cylinder extending between the base support 14 and the seat plate 26, for controlling the angle of the seat assembly 20 and the angle of the back assembly 40 connected therewith. In the embodiment shown, the angulation adjustment system 110 further includes a pivoting mechanism 114 allowing pivoting of the back assembly 40 with regard to the seat assembly 20 and locking of the back assembly 40 in the desired angular position. In an embodiment, a support guide 116 is also provided between the base support 14 and the back plate 46. In an embodiment (not shown) the support guide 116 could include a locking knob (not shown).

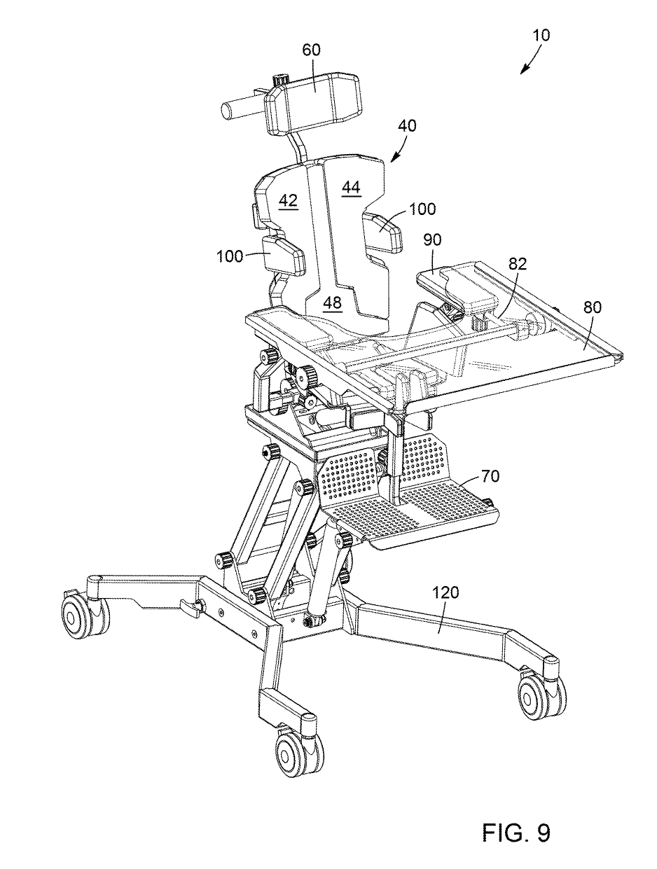

Turning to FIGS. 3 and 9, the chair assembly 10 can be mounted on bases of several different types. For example and without being limitative, in FIG. 9 the chair assembly 10 is mounted on a rolling base 120. One skilled in the art will however understand that the chair assembly 10 can be transferred to other bases such as a fixed base, a wheelchair base, a stroller base, a game station base or the like. In order to allow easy mounting/dismounting of the chair assembly 10 to the corresponding bases 120, in the embodiment shown, the chair assembly 10 has a connecting interface 122 at a lower surface of the base support 14. The connecting interface 122 allows quick engagement and release of the chair assembly with corresponding bases 120.

In view of the above, the chair assembly 10 described herein provides an easily adjusted chair having an adjustment system attached to a frame (or central structure) and the ability to nest inserts at the seat assembly and back assembly of the chair to compensate for gaps created by expansion of the structure at the seat assembly and/or back assembly of the chair. The chair assembly 10 can be adjusted quickly and can adjust on a width, height and depth of the seat assembly and back assembly of the chair. This new way to adjust the chair assembly provides increased adaptability and ease of adjustment, without tools. Moreover, in an embodiment the cushioned pads and/or inserts are easily removable and the material used is easily washable. On a visual level, the chair is compact and enables easy transport when one wishes to mount it on a base such as a stroller, a wheelchair, or the like, to facilitate travel. In an embodiment, the chair assembly 10 can also help optimize everyday occupational performance of children and facilitate their social integration as it allows mounting to bases of different height which can help levelling a child with children of its age for different activities.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. An adjustable chair assembly comprising:
a frame;
a seat assembly extending along a seat plane and operatively connected to the frame, the seat assembly comprising a first seat element and a second seat element adjustably positionable with respect to one another along the seat plane and together defining a support surface of the seat assembly;
a back assembly extending along a back plane and operatively connected to the frame, the back assembly comprising a first back element and a second back element adjustably positionable with respect to one another along the back plane and together defining a support surface of the back assembly, positioning of the first back element and the second back element of the back assembly being independent from positioning of the first seat element and the second seat element of the seat assembly; and
wherein a central gap is defined in at least one of the support surface of the seat assembly and the support surface of the back assembly, the adjustable chair assembly comprising at least one of a seat space-filling element and a back space-filling element removably insertable in the central gap of the corresponding one of the support surface of the seat assembly and the support surface of the back assembly to substantially fill the corresponding central gap.

2. The adjustable chair assembly of claim 1, wherein the support surface of the seat assembly and the support surface of the back assembly each have a central gap defined therein, the adjustable chair assembly comprising the seat space-filling element removably insertable in the central gap defined in the support surface of the seat assembly and the back space-filling element removably insertable in the central gap defined in the support surface of the back assembly.

3. The adjustable chair assembly of claim 2, wherein the central gap defined in the support surface of the seat assembly and the central gap defined in the support surface of the back assembly are expandable and wherein the adjustable chair assembly comprises a plurality of seat space-filling elements of varying sizes removably insertable in the central gap defined in the support surface of the seat assembly and a plurality of back space-filling elements of varying sizes removably insertable in the central gap defined in the support surface of the back assembly.

4. The adjustable chair assembly of claim 3, wherein a size of each one of the plurality of seat space-filling elements and back space-filling elements is calculated to match a size of at least one of the seating assembly and the back assembly according to statistical sizing charts for desired users of the adjustable chair assembly.

5. The adjustable chair assembly of claim 1, wherein the first seat element and the second seat element of the seat assembly are each movable along a lateral axis and a longitudinal axis of the seat plane.

6. The adjustable chair assembly of claim 1, wherein the first back element and the second back element of the back assembly are each movable along a lateral axis and a vertical axis of the back plane.

7. The adjustable chair assembly of claim 1, wherein the frame includes a base support operatively connected to a seat plate and a back plate, the first seat element and the second seat element of the seat assembly being adjustably securable to the seat plate and the first back element and the second back element of the back assembly being adjustably securable to the back plate.

8. The adjustable chair assembly of claim 7, wherein the first seat element and the second seat element each include a base and a cushioned pad securable to the plate, the seat assembly further comprising a seat positioning system including a comb-shaped slot defined in the seat plate for each one of the first seat element and the second seat element with a threaded pin extending from the base of each one of the first seat element and the second seat element and engageable in the corresponding comb-shaped slot, each threaded pin having a knob for tightening thereof.

9. The adjustable chair assembly of claim 8, wherein the comb-shaped slot defined in the seat plate for each one of the first seat element and the second seat element is oriented to define a plurality of laterally extending slots connected at one end to a longitudinally extending slot.

10. The adjustable chair assembly of claim 7, wherein the first back element and the second back element each include a base and a cushioned pad securable to the plate, the back assembly further comprising a back positioning system including a comb-shaped slot defined in the back plate for each one of the first back element and the second back element with a threaded pin extending from the base of each one of the first back element and the second back element and engageable in the corresponding comb-shaped slot, each threaded pin having a knob for tightening thereof.

11. The adjustable chair assembly of claim 10, wherein the comb-shaped slot defined in the back plate for each one of the first back element and the second back element is oriented to define a plurality of laterally extending slots connected at one end to a vertically extending slot.

12. The adjustable chair assembly of claim 1, wherein the at least one of the seat space-filling element and the back space-filling element includes a cushioned insert.

13. An adjustable chair assembly comprising:
a frame having a base support operatively connected to a seat plate and a back plate;
a seat assembly extending along a seat plane, the seat assembly comprising a first seat element and a second seat element adjustably securable to the seat plate and extending along the seat plane, the first seat element and the second seat element together defining a support surface of the seat assembly with a central gap defined therein;
a back assembly extending along a back plane, the back assembly comprising a first back element and a second back element adjustably securable to the back plate and extending along the back plane, the first back element and the second back element together defining a support surface of the back assembly with a central gap defined therein;
a seat space-filling element removably insertable in the central gap defined in the support surface of the seat assembly and substantially filling the central gap thereof; and
a back space-filling element removably insertable in the central gap defined in the support surface of the back assembly and substantially filling the central gap thereof.

14. The adjustable chair assembly of claim 13, wherein the central gap defined in the support surface of the seat assembly is expandable and wherein the adjustable chair assembly comprises a plurality of seat space-filling elements of varying sizes removably insertable in the central gap defined in the support surface of the seat assembly.

15. The adjustable chair assembly of claim 13, wherein the central gap defined in the support surface of the back assembly is expandable and wherein the adjustable chair assembly comprises a plurality of back space-filling elements of varying sizes removably insertable in the central gap defined in the support surface of the back assembly.

16. The adjustable chair assembly of claim 13, wherein the first seat element and the second seat element of the seat assembly are each movable along a lateral axis and a longitudinal axis of the seat plane.

17. The adjustable chair assembly of claim 16, wherein the first seat element and the second seat element each include a base and a cushioned pad securable to the plate, the seat assembly further comprising a seat positioning system including a comb-shaped slot defined in the seat plate for each one of the first seat element and the second seat element with a threaded pin extending from the base of each one of the first seat element and the second seat element and engageable in the corresponding comb-shaped slot, each threaded pin having a knob for tightening thereof.

18. The adjustable chair assembly of claim 17, wherein the comb-shaped slot defined in the seat plate for each one of the first seat element and the second seat element is oriented to define a plurality of laterally extending slots connected at one end to a longitudinally extending slot.

19. The adjustable chair assembly of claim 13, wherein the first back element and the second back element of the back assembly are each movable along a lateral axis and a vertical axis of the back plane.

20. The adjustable chair assembly of claim 19, wherein the first back element and the second back element each include a base and a cushioned pad securable to the plate, the back assembly further comprising a back positioning system including a comb-shaped slot defined in the back plate for each one of the first back element and the second back element with a threaded pin extending from the base of each one of the first back element and the second back element and engageable in the corresponding comb-shaped slot, each threaded pin having a knob for tightening thereof.

21. The adjustable chair assembly of claim 20, wherein the comb-shaped slot defined in the back plate for each one of the first back element and the second back element is oriented to define a plurality of laterally extending slots connected at one end to a vertically extending slot.
